(19) United States
(12) Patent Application Publication
(10) Pub. No.: US 2005/0195180 A1
(43) Pub. Date: Sep. 8, 2005

(54) Method for displaying additional colors

(75) Inventors: Ben-Chuan Du, Shindian City (TW); Yi-Wen Cheng, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/073,810

(22) Filed: Mar. 7, 2005

(30) Foreign Application Priority Data
Mar. 8, 2004 (TW) 93106088

(51) Int. Cl. G02F 1/1339

(52) U.S. Cl. 345/204

(57) ABSTRACT

A method of displaying additional colors is provided to enable a flat panel display (FPD) to display a required color which is originally unavailable due to hardware limitations of the FPD by using two available colors of the FPD, such as, a first and a second color. At least a pixel of the FPD is initiated to display the first color and a response time of the FPD is allowed to substantially elapse. Next, the pixel is initiated to display the second color, and at least a time equivalent to a display-achieving period is allowed to elapse, in which the period is based on, numerically, the first and second colors, the required color, and the response time. The pixel is then initiated to change its color alternately in a sufficiently small scale, thus achieving displaying the required color substantially.

This application claims the benefit of Taiwan application Serial No. 093106088, filed Mar. 8, 2004, the subject matter of which is incorporated herein by reference.

### BACKGROUND OF THE INVENTION

1. Field of the Invention

The invention relates in general to a method of displaying additional colors, and more particularly to a method of displaying additional colors for applying in flat panel displays.

2. Description of the Related Art

Conventionally, portable devices on the market, such as cellular phones, PDAs (Personal Digital Assistant), and electronic dictionaries etc., use flat panel displays (FPD), such as LCDs (liquid crystal display), as means for displaying. LCDs can be categorized into black and white displays, gray scale displays, and color displays etc., where color displays are further categorized into 256 colors, 4096 colors, and 65536 colors etc. Every LCD in the category has hardware limitations, where every dot pixel on the LCD can only display a certain number of colors within a limited range. The limitations on colors are due to data required by a pixel; for example, every pixel of a black and white display only requires one 1 bit, every pixel of a gray scale display requires 2 bits, and every pixel of the color displays of 256 colors, 4096 colors, and 65536 each requires 8, 12 and 16 bits respectively.

To overcome these hardware limitations so as to increase colors in addition to ones limited by the display, the conventional method is to utilize the effects of human perception: when observing from sufficient distance, human eyes are inclined to “average out” details of a small region of light intensity. Thus, to display different gray levels, for instance, a black and white display utilizes crossing black and white lines or patterns, known as halftone patterns, to form the required picture. When a small region of the patterns or lines is sufficiently distant from an observer, the small region appears gray, thus achieving the desired visual effects.

However, a disadvantage of such method is that when the observer is very close to the display, or when the desired display region is very small, these halftone patterns can be distinctly identified as merely crossing black and white lines or patterns; hence, the above described visual effects can not be achieved. With regards to the display of a portable device, such as the LCD screen of a cellular phone, the method of increasing gray levels described above can only have limited visual effects. Thus, the method of increasing gray level described above is only applicable in large displays that display the same colors, and are not valid in small displays.

Due to the increasing demand by users inportable devices having displays capable of displaying vivid colors, if one can overcome the hardware limitations associated with these displays while maintaining good visual perception, and can increase display colors that are a multiple times more than the ones currently limited, then the greatest economic benefits can be attained, especially during a time when hardware is yet fully developed, or when prices are high.

### SUMMARY OF THE INVENTION

It is therefore an object of the invention to provide a method of displaying additional colors. The method can overcome hardware limitations of a FPD, and while maintaining good visual perception, enabling the FPD to display colors originally unavailable due to such limitations, so that the effects of true colors can be shown even in a small region of the display.

The invention achieves the above-identified effects by providing a method of displaying additional colors, enabling a FPD to display a required color, which is originally unavailable due to hardware limitations of the FPD. The FPD includes a plurality of available colors and a response time. The method of displaying additional colors includes the following steps. a. A first color and a second color are selected from the available colors, wherein the first color and the second color respectively correspond to a first color value and a second color value, and a required color value corresponding to the required color is between the first color value and the second color value. b. A display-achieving period is determined for displaying the required color, wherein the display-achieving period is determined basing on the response time and, numerically, the first color value, the second color value, and the required color value. c. A request for at least a pixel of the FPD to display the first color is initiated. d. When the pixel displays the first color, color displayed by the pixel is enabled to approach the required color by initiating the pixel to display the second color and by allowing at least the display-achieving period to elapse. e. The pixel is enabled to display the required color substantially by initiating requests for the pixel to display the first color and the second color alternately and by allowing an alternation time to substantially elapse between the requests which are initiated alternately, wherein the alternation time is less than the response time.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is flow chart showing a method of displaying additional colors according to a better embodiment of the invention.

FIG. 2 shows a diagram illustrating the method of displaying additional colors of FIG. 1 as described in the first embodiment.

### DETAILED DESCRIPTION OF THE INVENTION

The invention discloses a method of displaying additional colors, enabling a flat panel display (FPD), such as a LCD, to display a required color originally unavailable due to hardware limitations of the FPD. The FPD has a plurality of available colors and a response time.

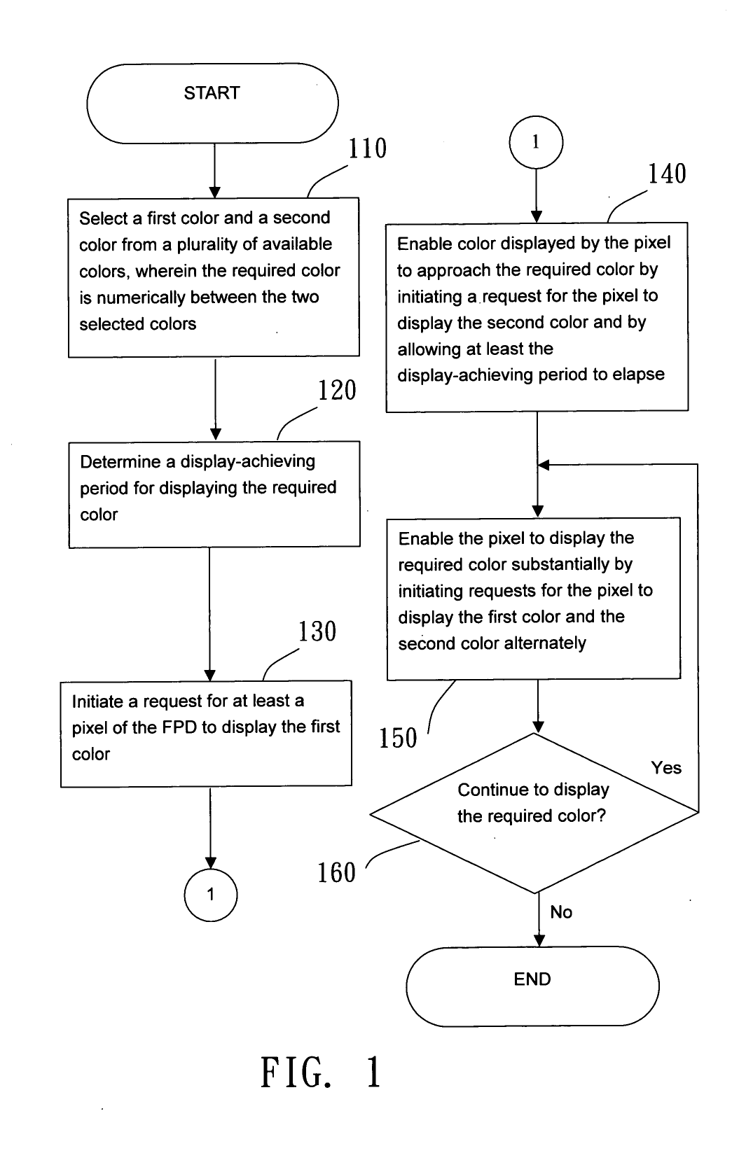

FIG. 1 shows a flow diagram illustrating the method of displaying additional colors. As shown in step 110, a first color and a second color is selected from the available colors. The first and second colors respectively correspond to a first color value and a second color value, wherein a required color value corresponding to the required color is between the first color value and the second color value. Then, in step 120, a display-achieving period is determined, for displaying the required color, wherein the display-achieving period is determined basing on the response time and, numerically, the first color value, the second color value, and the required color value. When the first color, the second color, and the display-achieving period are determined from the above step, the method further includes the following steps to initiate the FPD to display the required color.

In step 130, a request for at least a pixel (or a region of pixels) of the FPD to display the first color is initiated and at least the response time is allowed to elapse before the next step is proceeded. Then, in step 140, a request for the pixel to display the second color is initiated and at least the display-achieving period is substantially allowed to elapse before the next step is proceeded, causing the colors displayed by the pixel to substantially approach the required color. After that, in step 150, the pixel is enabled display the required color substantially by initiating requests for the pixel to display the first color and the second color alternately and by allowing an alternation time to substantially elapse between the requests which are initiated alternately, wherein the alternation time is less than the response time. The action where the initiating of the requests for the pixel to display the first color and second color alternately in step 150 continues until the required color does not need to be displayed. As shown in step 160, if the required color needs to be continuously displayed, then step 150 remains operating. If the required color does not need to be displayed, then step 150 ceases operation, and the method of displaying additional colors ends.

According to the method described above of displaying additional colors, in step 120, the display-achieving period is settable based on the hardware characteristics of the FPD; thus, the effects of the required color can be achieved in spite of different hardware characteristics. For example, the display-achieving period can be determined basing on numerical difference between the first color value and the required color value, numerical difference between the first color value and the second color value, and the response time.

Under normal circumstances, the response time and values of the colors can be regarded as having a linear relationship. Thus, the display-achieving period is determined mathematically by dividing numerical difference between the first color value and the desired color value by numerical difference between the first color value and the second color value, then multiplying by the response time. If the first color value, the required color value, the second color value, the response time, and the display-achieving period are denoted by X, Y, Z, T, and T_{XY} respectively, then when the response time and the color values are linearly proportional, the display-achieving time can be represented as:
T_{XY}=|(X−Y)/(X−Z)*T|. (E1)

After the display-achieving period is determined, the method of the invention is to utilize the characteristic of the FPD (namely the color displayed by a pixel of the FPD needs to go through a response time before transforming from an available color to another available color i.e. another possible level), in order to achieve the displaying of the required color substantially. During the process of level changing, if the color displayed by the pixel can be alternately initiated between different directions when the color displayed by the pixels approaches the level of the required color, then the color displayed by the pixel is enabled to be the level of the required color substantially. This method can accordingly used in the FPD to overcome the limitation that only the available colors can be displayed due to hardware limitations.

Therefore, as described in step 140, by initiating a request for the pixel to display the second color and allowing at least the display-achieving period to substantially elapse, colors displayed by the pixel can substantially approach the required color. The period allowed to be elapsed in step 140 can be regarded substantially as the sum of the display-achieving period and a delay period, wherein the delay period is less than the display-achieving period. Then, in step 150, the color displayed by the pixel changes alternately in a sufficiently small scale, thus achieving the displaying of the required color substantially.

In order for the color pixel displayed by the pixel to change alternately in a sufficiently small scale approaching the required level, an alternation time is allowed to substantially elapse between two successive ones of the requests which are initiated alternately. To allow the pixel to continue displaying the required color steadily, the alternation time of step 150 is substantially determined by the delay period; for instance, the alternation time is substantially twice of the delay period. In addition, the alternation time is sufficiently less than the response time so as to allow the pixel to continue displaying the required color steadily.

Next, through exemplary embodiments, the method of displaying additional colors for enabling a FPD to display a required color under the invention will be thoroughly discussed. The required color is originally unavailable due to hardware limitations of the FPD. The FPD can be a liquid crystal display (LCD), such as a LCD of a portable device (such as a cellular phone, PDA etc.). A liquid crystal display is provided in these embodiments with a response time of T that equals 300 ms, and the hardware design yielding a display of 256 colors. Each pixel of the LCD requires 8 bits of data for representation (such as a byte with RRRGGGBB sequence), specifically, the 3 bits are used for red, 3 bits are used for green, and 2 bits are used for blue; for instance, the color red provides 8 selectable levels.

In the following two embodiments, the color value corresponding to the required color is a red color level between bit representation 11100000 and 11000000, and is closer to 11100000.

In the first embodiment, first, a first color (referred to as color X for short) and a second color (color Z for short) of closest resemblance to the required color (color Y for short) are selected from the available colors, i.e. the above mentioned 256 colors, in which color Y is numerically between color X and color Z. In the first embodiment, color Y is numerically greater than color X and smaller than color Z; for instance, color X and color Y has respective value of 11000000 and 11100000. Next, a display-achieving period T_{xy} is determined according to the response time, for displaying the required color. To simplify the calculations for the display-achieving period, at this time, value of color X and color Z can be assumed to be X=0, Z=1 respectively, and from the color weighting of color Y, the value of color Y is found to be 0.7. Thus, T_{XY} can be found from expression E1: T_{XY}=0.7*300=210 ms.

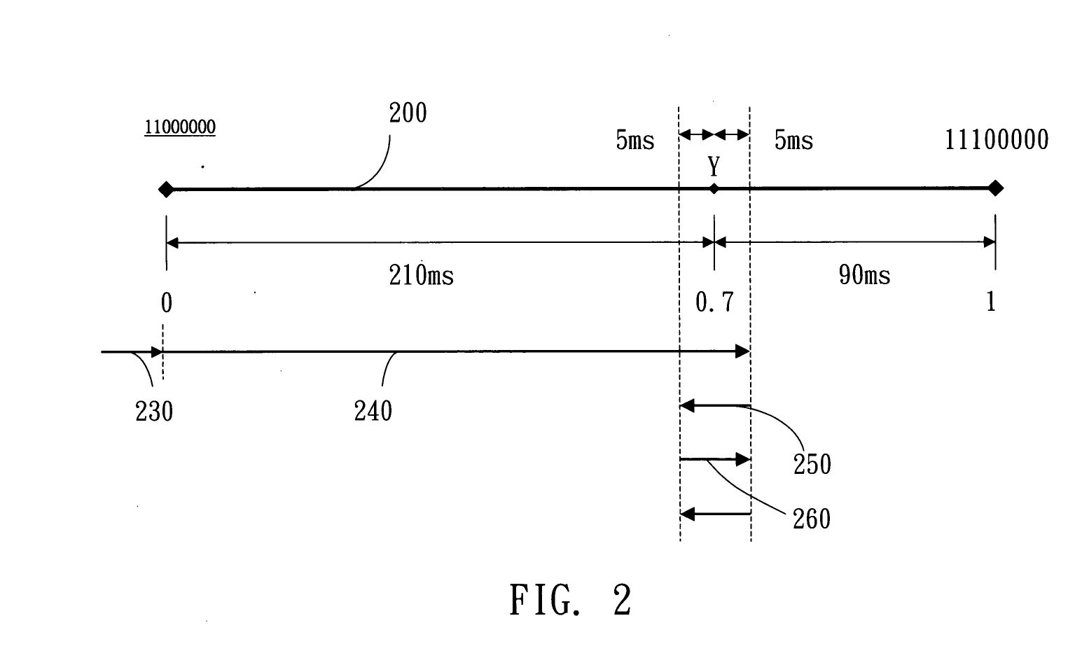

After color X, color Z and the display-achieving period T_{xy} are determined from above, the first embodiment goes through the following steps for initiating the LCD to display color Y. Referring to FIG. 2, axis 200 is an axis representing the states while the pixels are changing color. Arrows 230, 230, 250 and 260 are all used to represent the states of every step of the color change of the pixels. Please note that the labels and arrows are not drawn to scale.

### First Embodiment

In the first phase of the first embodiment, through sending data or request to LCD (such as using an application program to output drawing instructions, then through an operating system to send the instructions to the LCD), pixels (or at least one of the pixels) of a region of the LCD is initiated to display color X and approximately in time equivalent to the response time of T=300 ms is allowed to elapse. At this time, the selected pixels on the LCD display color X, which is the color represented by 11000000. Referring to FIG. 2, the head of the arrow 230 representing the first phase corresponds to location of 11000000 on the axis 200, indicating that the color displayed by the pixels has changed to color X.

The second phase is then entered. Through sending data or request to LCD, the pixels are initiated to display color Z and a time equivalent to the sum of display-achieving period T_{XY} and a delay period S of T_{XY}+S is allowed to elapse. As indicated by the arrow 240 that represents the second phase, at this time, the pixels that are selected to display color Y continue to change their colors, from color 11000000 to approaching color 11100000. S is set S=5 ms to be sufficiently less than T=300 ms, such that T_{XY}+S=215 ms. After a time of 215 ms, the colors displayed by the pixels are approaching the level of color Y, as indicated by the head of the arrow 240.

After that, the third phase is entered to enable the pixels to display color Y substantially through sending data to LCD or initiating requests for the pixels to display color X and color Z alternately, in which two successive requests, an alternation time is allowed to substantially elapse between two successive ones of the requests that are initiated alternately. The alternation time is twice of the delay period, i.e. T_{A}=2 S=10 ms. As shown in FIG. 2, the arrows representing the third phase, such as arrows 250 and 260, show that through sending data to LCD or the requests that are initiated alternately, the pixels are initiated to display color X and an alternation period is allowed to substantially elapse, i.e. 10 ms, and to cause the colors displayed by the pixels to change towards 11000000; then, the pixels are initiated to display color Z and the alternation time is allowed to substantially to elapse, to cause the colors displayed by the pixels to change towards 11100000; the two steps are repeated until the required color Y no longer needs to be displayed. Hence, the colors displayed by the pixels change alternately in a small scale approaching color Y. Since the alternation time is sufficiently smaller than the response time, the pixels can continue to display color Y steadily until color Y does not need to be displayed, in which the color displayed by the pixels substantially is equivalent to color Y.

### Second Embodiment

In the second embodiment, the required color is same as in the first embodiment, and is referred to as color Y; when selecting color X and color Z, color Y is selected to be numerically smaller than color X and greater than color Z, and the selected value of color X and Z are respectively 11100000 and 11000000. Then, a display-achieving time T_{XY} is determined according to the response time, for displaying the required color. To simplify calculations for deriving display-achieving period, at this time, the value of color X is assumed to be X=1, the value of color Z is assumed to be Z=0, and the value of color Y is found to be 0.3 according to the color weighting of color Y. Thus, according to expression E1, T_{XY} is found: T_{xy}=0.3*300=90 ms.

When color X, color Z and display-achieving period T_{XY} are determined from the described step, the second embodiment goes through the following steps of initiating LCD for displaying color Y.

In the first stage of second embodiment, through sending data to the LCD or requests, a region of pixels (or at least a pixel) is initiated to display color X and a time equivalent to the response time of T=300 ms is allowed to elapse. At this time, the selected pixels of the LCD are displaying color X, namely the color represented by 11100000. Afterwards, through sending data to the LCD or requests, the pixels are initiated to display color Z, and a time equivalent to the sum of the display-achieving period T_{XY} and a delay period S of T_{XY}+S is allowed to elapse. At this time, the pixels that are selected to display color Y continue to change colors, from color X to approaching color Z, i.e. from the color represented by 11100000 approaching 11000000, which is the opposite as compared to the first embodiment. S is selected to be sufficiently less than T=300 ms with a time of S=5 ms, i.e. T_{xy}+S=95 ms. After 95 ms has past, the color displayed by the pixels has approached the level of color Y. Meanwhile, entering stage three, the pixels are initiated to alternately display color X and color Z, wherein an alternation time T_{A}, such as T_{A}=2 S=10 ms, is allowed to elapse between two successive ones of the requests that are initiated alternately. Thus, the colors displayed by the pixels change in a small scale approaching the level of color Y, which substantially equals color Y, until color Y does not need to be displayed.

The two embodiments of the invention as described disclose the method of displaying additional colors for enabling a flat panel display to display a required color which is originally unavailable due to hardware limitations of the FPD by using two available colors of the FPD, and thus overcoming these hardware limitations. Since the present method allows FPD to display the required color steadily, thus, while maintaining good visual perception, the true color effect can be substantially achieved even in small regions. During a time when hardware is yet fully developed, or when prices remain high, if the weighting of the value of color Y is set as described above, display colors can be increased by a multiple times more than the ones currently limited by display hardware. To displays of portable devices, such as the LCD of cellular phones, the method of displaying additional colors under the invention can increase more colors than the originally available colors of the LCD, and good visual effects can be achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of displaying additional colors, for enabling a FPD (flat panel display) to display a required color, the FPD having a plurality of available colors and a response time, the method of displaying additional colors comprising:
a. selecting a first color and a second color from the available colors, the first color and the second color respectively corresponding to a first color value and a second color value, wherein a required color value corresponding to the required color is between the first color value and the second color value;
b. determining a display-achieving period, for displaying the required color, wherein the display-achieving period is determined based on the response time, the first color value, the second color value, and the required color value;
c. initiating a request for at least a pixel of the FPD to display the first color;
d. when the pixel displays the first color, enabling color displayed by the pixel to approach the required color by initiating a request for the pixel to display the second color and by allowing at least the display-achieving period to elapse before proceeding to step e; and
e. enabling the pixel to display the required color substantially by initiating requests for the pixel to display the first color and the second color alternately and by allowing an alternation time to substantially elapse between the requests which are initiated alternately, until the required color does not need to be displayed, wherein the alternation time is less than the response time.

2. The method of displaying additional colors according to claim 1, wherein during step b:
the display-achieving period is determined based on numerical difference between the first color value and the required color value, numerical difference between the first color value and the second color value, and the response time.

3. The method of displaying additional colors according to claim 1, wherein during step b:
the display-achieving time is determined mathematically by dividing numerical difference between the first color value and the desired color value by numerical difference between the first color value and the second color value, and multiplying by the response time.

4. The method for displaying additional colors according to claim 1, wherein in step d:
allowing substantially a period equivalent to sum of the display-achieving period and a delay period to elapse before proceeding to step e, wherein the delay period is less than the display-achieving period.

5. The method for displaying additional colors according to claim 4, wherein during step e:
the alternation time is substantially determined by the delay period.

6. The method of displaying additional colors according to claim 5, wherein during step e:
the alternation time is sufficiently less than the response time for allowing the pixel to continue displaying the required color steadily.

7. The method of displaying additional colors according to claim 1, wherein during step e:
the alternation time is sufficiently less than the response time for allowing the pixel to continue displaying the required color steadily.

8. The method of displaying additional colors according to claim 1, wherein the required color value is greater than the first color value and smaller than the second color value.

9. The method of displaying additional colors according to claim 1, wherein the required color value is smaller than the first color value and greater than the second color value.

10. The method of displaying additional colors according to claim 1, wherein step e comprises:
e1. initiating a request for the pixel to display the first color and substantially allowing the alternation time to elapse before proceeding to the following step;
e2. initiating a request for the pixel to display the second color and substantially allowing the alternation time to elapse before proceeding to the following step; and
e3. repeating steps e1 and e2 until the required color does not need to be displayed.

11. The method of displaying additional colors according to claim 1, wherein the FDP is a liquid crystal display.

12. A method of displaying additional colors for enabling a flat panel display (FDP) to display a required color originally unavailable due to hardware limitations of the FPD, the FDP having a plurality of available colors and a response time, the method of displaying additional colors comprising:
a. selecting a first color and a second color from the available colors, the first color and the second color respectively corresponding to a first color value and a second color value, wherein a required color value corresponding to the required color is between the first color value and the second color value;
b. determining a display-achieving period for displaying the required color, wherein the display-achieving period is determined based on mathematically dividing the numerical difference between the first color value and the required color value by the numerical difference between the first color value and the second color value, and then multiplying by the response time;
c. initiating a request for at least a pixel of the FPD to display the first color;
d. when the pixel displays the first color, enabling color displayed by the pixel to approach the required color by initiating a request for the pixel to display the second color and by allowing a period equivalent to sum of the display-achieving period and a delay period to elapse before proceeding to step e, wherein the delay period is less than the display-achieving period; and
e. enabling the pixel to display the required color substantially by initiating requests for the pixel to display the first color and second color alternately and by allowing an alternation time to substantially elapse between the requests which are initiated alternately, until the required color does not need to be displayed, wherein the alternation time is less than the response time.

13. The method of displaying additional colors according to claim 12, wherein
the required color value is greater than the first color value and smaller than the second color value.

14. The method of displaying additional colors according to claim 13, wherein step e comprises:
e1. initiating a request for the pixel to display the first color and substantially allowing the alternation time to elapse before proceeding to the following step;
e2. initiating a request for the pixel to display the second color and substantially allowing the alternation time to elapse before proceeding to the following step; and
e3. repeating steps e1 and e2 until the required color does not need to be displayed.

15. The method of displaying additional colors according to claim 14, wherein the alternation time is substantially twice of the delay period.

16. The method of displaying additional colors according to claim 12, wherein
the required color value is smaller than the first color value and greater than the second color value.

17. The method of displaying additional colors according to claim 13, wherein step e comprising:
e1. initiating a request for the pixel to display the first color and substantially allowing the alternation time to elapse before proceeding to the following step;
e2. initiating a request for the pixel to display the second color and substantially allowing the alternation time to elapse before proceeding to the following step; and
e3. repeating steps e1 and e2 until the required color does not need to be displayed.

18. The method of displaying additional colors according to claim 17, wherein the alternation time is substantially twice of the delay period.

19. The method of displaying additional colors according to claim 12, wherein the FPD is a liquid color display.

20. The method of displaying additional colors according to claim 19, wherein the FPD is a liquid crystal display of a portable device
